(19) United States
(12) Patent Application Publication
(10) Pub. No.: US 2015/0061858 A1
(43) Pub. Date: Mar. 5, 2015

(54) ALERT FILTER FOR DEFINING RULES FOR PROCESSING RECEIVED ALERTS

(71) Applicant: James R. Malnati, Stillwater, MN (US)

(72) Inventor: James R. Malnati, Stillwater, MN (US)

(73) Assignee: Unisys Corporation, Blue Bell, PA (US)

(21) Appl. No.: 14/011,839

(22) Filed: Aug. 28, 2013

(51) Int. Cl. G08B 23/00

(52) U.S. Cl. CPC G08B 23/00
USPC 340/501

(57) ABSTRACT

A list of alert filters may be used to alert alerts generated by remote machines. For example, received alerts may be compared to the list of alert filters. When an alert filter matches the received alert, a new action may be taken by the monitoring agent, such as to raise or lower a priority of the alert or to take an action to message an administrator. When no alert filter matches the alert, a default action for the alert may be taken.

### FIELD OF THE DISCLOSURE

The instant disclosure relates to computer networks. More specifically, this disclosure relates to monitoring of computer systems on a computer network.

### BACKGROUND

Computer systems, and servers in particular, form an information backbone upon which companies now rely on almost exclusively for data storage, data mining, and data processing. These systems are indispensable for the improved efficiency and accuracy at processing data as compared to manual human processing. Furthermore, these systems provide services that could not be realistically accomplished by human processing. For example, some computer systems execute physical simulations in hours that would otherwise take decades to complete by human computations. As another example, some computer systems store terabytes of data and provide instantaneous access to any of the data, which may include records spanning decades of company operations.

Monitoring these computers systems is a top priority for their operators and administrators to ensure that the computer systems are continuously available without interruption. During monitoring of these computer systems, alerts may be generated to provide information to or warn an administrator of the status of the computer system. However, alerts generated during monitoring of the computer systems may be numerous. Conventionally, the alerts must be cleared manually and the administrator may be informed through a phone call, a manual email, a text message, or the like. When an administrator receives a large number of alerts, in which only a few are critical, the administrator may miss the critical alert. Thus, there is a need for a better alert system for monitoring computer systems.

### SUMMARY

Alert filters may be defined to automate alert handling with customized actions, which may not require real-time operator intervention. A monitoring agent, such as the Unisys Operations Sentinel (SPO), may filter alerts according to an alert policy. Alerts in the agent may include an alert ID, and when a given alert ID is also specified in the alert policy an action may be taken based on the alert policy, such as sending the alert by email and/or text message, Simple Network Message Protocol (SNMP) Trap, audible alert, and or another action.

Alert ID filtering and customized post-processing may be performed based, at least in part, on a configuration file wherein certain alert IDs are listed along with the preferred actions. Many alerts may be raised with predictable beginning sequences but unpredictable ending characters. For instance, one particular networking alert may always begin with the string “Dns:20” but may end with any number of integers. An alert filter may be set up to match this alert ID. When alert filters match, the alert may be cleared or raised with a new severity, either lower or higher than the original. The alert may also be raise with a different alert ID, to allow a different alert actions to be taken.

According to one embodiment, a method may include receiving, by a monitoring system, an alert. The method may also include comparing, by the monitoring system, the received alert to a list of alert filters. The method may further include, when an alert filter matches the received alert, executing, by the monitoring system, a logical rule on the received alert, wherein the logical rule corresponds to a matched alert filter of the list of alert filters.

According to another embodiment, a computer program product having non-transitory computer readable medium. The medium may include code to perform the step of receiving an alert. The medium may also include code to perform the step of comparing the received alert to a list of alert filters. The medium may further include code to perform the step of executing a logical rule on the received alert, wherein the logical rule corresponds to a matched alert filter of the list of alert filters when an alert filter matches the received alert.

According to yet another embodiment, an apparatus includes a memory and a processor coupled to the memory. The processor may be configured to execute the step of receiving an alert. The processor may also be configured to execute the step of comparing the received alert to a list of alert filters. The processor may further be configured to execute the step of executing a logical rule on the received alert, wherein the logical rule corresponds to a matched alert filter of the list of alert filters when an alert filter matches the received alert.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a method of filtering alerts according to one embodiment of the disclosure.

FIG. 2 is an alert filter configuration file according to one embodiment of the disclosure.

FIG. 3 is a flow chart illustrating a method of matching alerts to alert filters according to one embodiment of the disclosure.

FIG. 4 is a block diagram illustrating a computer network according to one embodiment of the disclosure.

FIG. 5 is a block diagram illustrating a computer system according to one embodiment of the disclosure.

### DETAILED DESCRIPTION

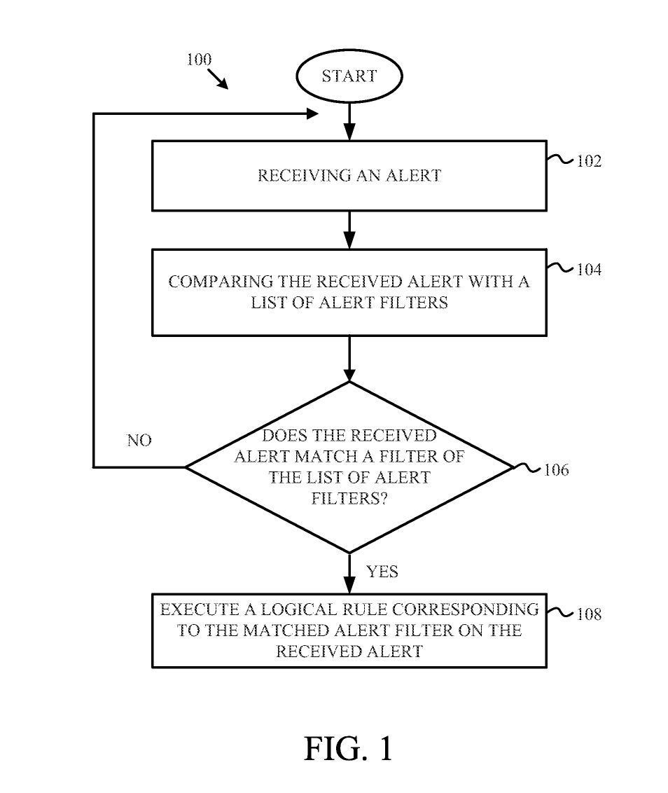

FIG. 1 is a flow chart illustrating a method of filtering alerts according to one embodiment of the disclosure. A method 100 begins at block 102 with receiving an alert. The alert may be generated through an application programming interface (API), a simple network management protocol (SNMP) message, or the like.

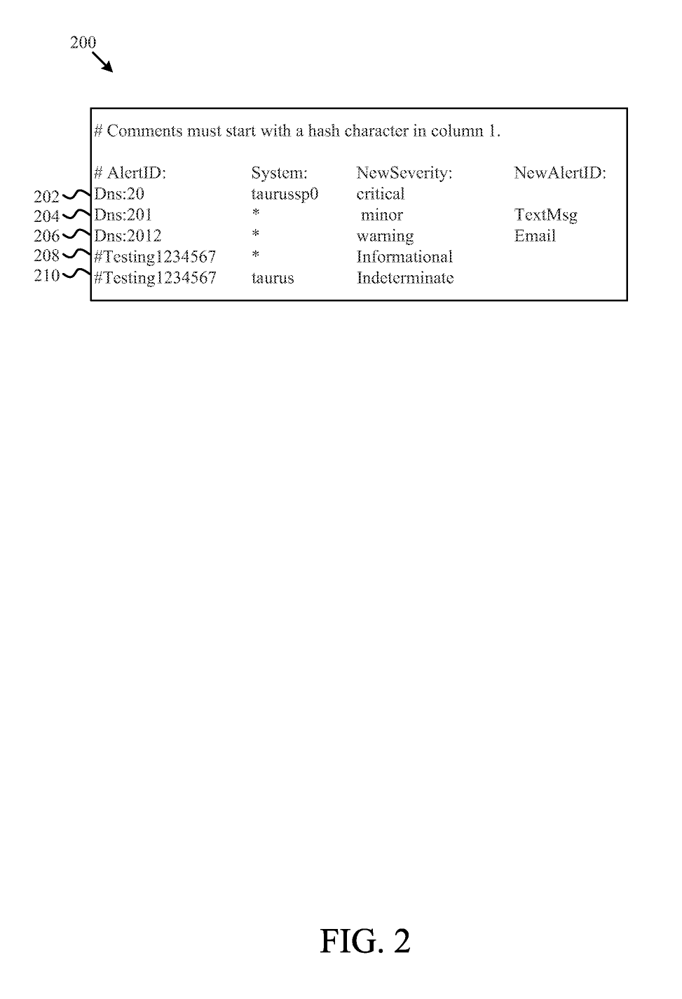

At block 104, the received alert may be compared with a list of alert filters. The list of alert filters for comparison at block 104 may be obtained by reading a configuration file. FIG. 2 is an alert filter configuration file according to one embodiment of the disclosure. A configuration file 200 may be referenced by a script, such as a VBScript, that is called to compare the list of alert filters with the received alert. The configuration file 200 may include an alert filter 202 to match alerts with an alert id of “Dns:20” from a system named “taurusp0,” an alert filter 204 to match alerts with an alert id of “Dns:201” from any system, an alert filter 206 to match alerts with an alert id of “Dns:2012” from any system. Note that alert filter 208 is commented out and will not match alerts with an alert id of “#Testing1234567” from any system. Nor will alert filter 210 match alerts with an alert id of “#Testing1234567” from a system named “Taurus” for the same reason. The ability to “comment out” proposed alert filter items is a crucial component in rapid prototyping different options for alert handling. The configuration file 200 may also define actions to take when one of the alert filters 202, 204, and 206 match a received alert. For example, the alert filter 202 defines a new severity for the alert as “critical,” the alert filter 204 defines a new severity for the alert as “minor” and a new alert ID as “TextMsg,” the alert filter 206 defines a new severity for the alert as “warning” and a new alert ID as “Email,” the alert filter 208 (when the “#” character is removed) defines a new severity for the alert as “informational,” and the alert filter 210 (also when commented in) defines a new severity for the alert as “indeterminate.”

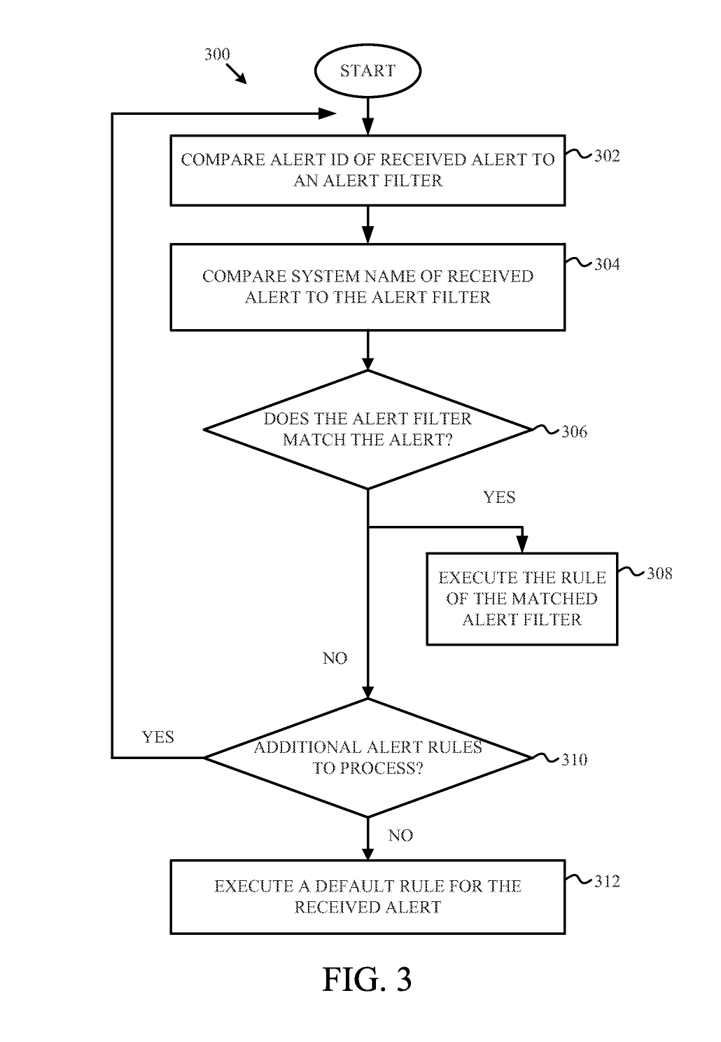

Returning to FIG. 1 at block 106, it is determined whether the received alert matches any alert filter in the list of alert filters. FIG. 3 is a flow chart illustrating a method of matching alerts to alert filters according to one embodiment of the disclosure. A method 300 begins at block 302 with comparing an alert ID of the received alert to an alert filter. At block 304, the system name of the received alert is compared to a system name of the alert filter. At block 306, it is determined whether the alert filter matches the received alert based on the comparison at blocks 302 and 304. Although only alert ID and system name fields of the received alert are compared in blocks 302 and 304, additional criteria may be compared to determine a match with an alert filter, such as a process name generating the received alert.

If the alert filter matches the received alert at block 306, a rule corresponding to the matched alert filter is executed at block 308. If the alert filter does not match the received alert at block 306, then it is determined if there are additional alert filters to process at block 310. If so, then the method 300 returns to block 302 to process another alert filter. If not, then the method 300 proceeds to block 312 to execute a default rule for the received alert.

When matching alert filters, more specific matches may be processed in preference to less specific matches. For example, a received alert with an alert ID of “Dns:201” may not match alert filters 202 and 204 of FIG. 2 with specified alert Ms of “Dns:20” or “Dns:2012,” but instead will match the alert filter 206 with specified alert ID of “Dns:201.”

Returning to FIG. 1, the method 100 continues to block 108 when an alert filter matches the received alert to execute a logical rule corresponding to the matched alert filter. For example, if an alert ID begins with any of the characters in the alert ID field or an alert filter, the alert may be re-raised with a different severity. In another example, if a system field is present in the alert filter, only matching alert IDs from that specific system may be re-raised. The list of alert filters may include multiple alert filter with different systems or the “*” (all) wild card may be used. For example, the alert filters 204, 206, and 208 (when commented. in) of FIG. 2 may match any system generating a certain alert ID. In certain alert filters, in addition to a new severity, a different alert ID may be specified, such as to trigger sending of a text message instead of an email, which could have been the default original action. For example, the alert filters 204 and 206 of FIG. 2 assign new alert IDs to alerts to change an action to sending of a text message and sending of an email message, respectively.

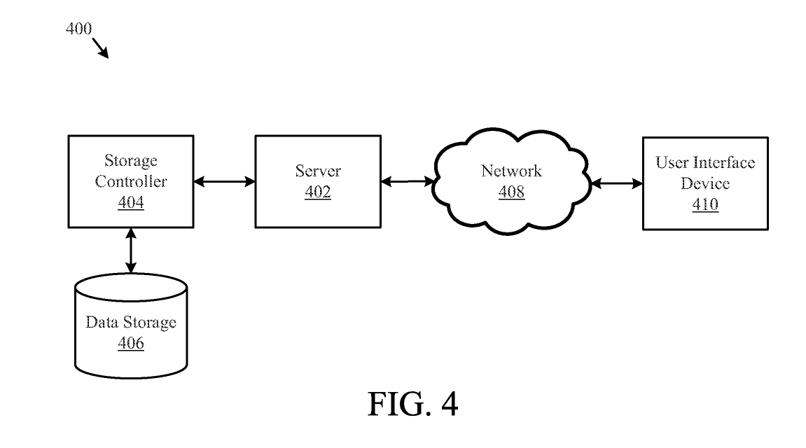

FIG. 4 illustrates one embodiment of a system 400 for an information system, including a system for processing alerts against an alert filter. The system 400 may include a server 402, a data storage device 406, a network 408, and a user interface device 410. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone, or other mobile communication device having access to the network 408. In a further embodiment, the user interface device 410 may access the Internet or other wide area or local area network to access a web application or web service hosted by the server 402 and may provide a user interface for specifying data for remote viewing of alerts and/or modifications of alert filters.

The network 408 may facilitate communications of data between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

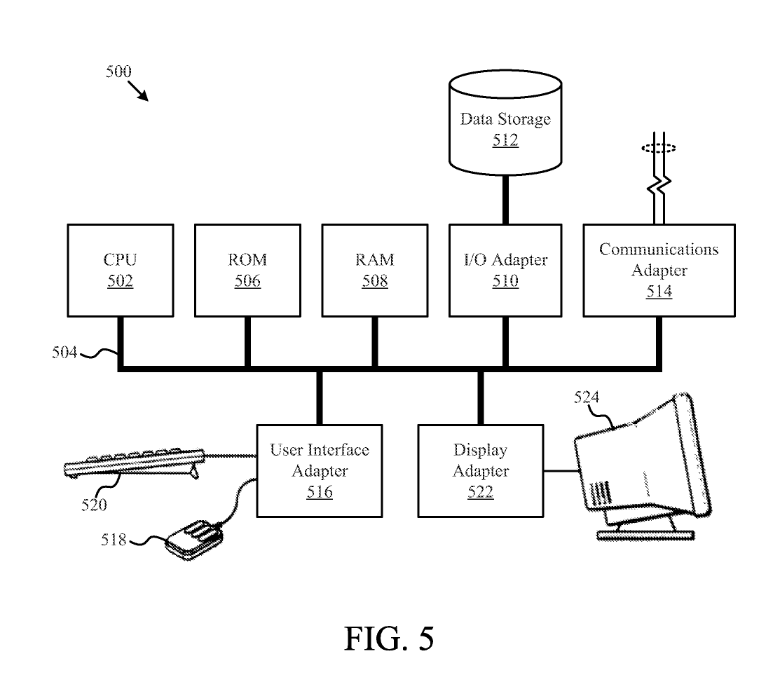

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 may also include random access Memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The user interface adapter 516 couples user input devices, such as a keyboard 520, a pointing device 518, and/or a touch screen (not shown) to the computer system 500. The keyboard 520 may be an on-screen keyboard displayed on a touch panel. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of the server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, by a monitoring system, an alert;
comparing, by the monitoring system, the received alert to a list of alert filters;
when an alert filter matches the received alert, executing, by the monitoring system, a logical rule on the received alert, the logical rule corresponding to a matched alert filter of the list of alert filters.

2. The method of claim 1, further comprising reading, by the agentless monitoring system, a configuration file comprising the list of alert filters.

3. The method of claim 1, in which the step of comparing comprises comparing at least one of an alert identifier and a system name.

4. The method of claim 1, in which the logical rule comprises at least one of assigning a new severity level to the received alert and assigning a new action to the received alert.

5. The method of claim 4, in which the new action comprises at least one of transmitting an email message, transmitting a text message, executing a simple network management protocol (SNMP) trap, and generating an audible alert.

6. The method of claim 1, further comprising when an alert filter does not match the received alert, executing a default action for the received alert.

7. The method of claim 1, in which the step of receiving the alert comprises receiving a simple network management protocol (SNMP) message.

8. A computer program product, comprising:
a non-transitory computer-readable medium comprising code to perform the steps of:
receiving an alert;
comparing the received alert to a list of alert filters;
when an alert filter matches the received alert, executing a logical rule on the received alert, the logical rule corresponding to a matched alert filter of the list of alert filters.

9. The computer program product of claim 8, in which the medium further comprises code to perform the step of reading a configuration file comprising the list of alert filters.

10. The computer program product of claim 8, in which the step of comparing comprises comparing at least one of an alert identifier and a system name.

11. The computer program product of claim 8, in which the logical rule comprises at least one of assigning a new severity level to the received alert and assigning a new action to the received alert.

12. The computer program product of claim 11, in which the new action comprises at least one of transmitting an email message, transmitting a text message, executing a simple network management protocol (SNMP) trap, and generating an audible alert.

13. The computer program product of claim 8, in which the medium further comprises code to perform the step of when an alert filter does not match the received alert, executing a default action for the received alert.

14. The computer program product of claim 8, in which the step of receiving the alert comprises receiving a simple network management protocol (SNMP) message.

15. An apparatus, comprising:
a memory; and
a processor coupled to the memory, in which the processor is configured to perform the steps of:
receiving an alert;
comparing the received alert to a list of alert filters;
when an alert filter of the list of alert filters matches the received alert, executing a logical rule on the received alert, the logical rule corresponding to a matched alert filter of the list of alert filters.

16. The apparatus of claim 15, in which the processor is further configured to perform the step of reading a configuration file comprising the list of alert filters.

17. The apparatus of claim 15, in which the step of comparing comprises comparing at least one of an alert identifier and a system name.

18. The apparatus of claim 15, in which the logical rule comprises at least one of assigning a new severity level to the received alert and assigning a new action to the received alert.

19. The apparatus of claim 18, in which the new action comprises at least one of transmitting an email message, transmitting a text message, executing a simple network management protocol (SNMP) trap, and generating an audible alert.

20. The apparatus of claim 15, in which the processor is further configured to perform the step of executing a default action for the received alert when an alert filter of the list of alert filters does not match the received alert.
